(19) United States
(12) Patent Application Publication
(10) Pub. No.: US 2026/0366733 A1
(43) Pub. Date: Nov. 19, 2026

(54) COOKING APPLIANCE

(71) Applicant: LG ELECTRONICS INC., Seoul (KR)

(72) Inventors: Eunjung SHIN, Seoul (KR); Hyeunsik NAM, Seoul (KR); Junghyeon CHO, Seoul (KR); Jonghyun LEE, Seoul (KR); Minha KIM, Seoul (KR)

(73) Assignee: LG ELECTRONICS INC., Seoul (KR)

(21) Appl. No.: 19/488,480

(22) PCT Filed: Nov. 15, 2024
(86) PCT No.: PCT/KR2024/018125

§ 371 Date: Nov. 26, 2025

(30) Foreign Application Priority Data
Nov. 23, 2023 (KR) 10-2023-0164202

(51) Int. Cl. F24C 15/10; F24C 7/06; F24C 15/22

(52) U.S. Cl. CPC F24C 15/102; F24C 7/067; F24C 15/22

(57) ABSTRACT

An embodiment of a cooking appliance may be provided with a cooktop comprising: a heating part for heating an object; an upper plate disposed above the heating part; and a top plate accommodating a portion of the heating part and having an upper surface on which the upper plate is disposed. The top plate includes: a cutout portion that is cut out of a region, in which the heating part is disposed, so that the upper plate and a heating coil face each other; and a bent extension portion that is bent at the edge of the cutout portion and extends downward, wherein an air gap for blocking heat conduction may be formed between a case and the bent extension portion.

### TECHNICAL FIELD

The present disclosure relates to a cooking appliance, and more particularly, to a cooking appliance having a structure with improved heating efficiency.

### BACKGROUND ART

The contents described in this section merely provides background information on the present disclosure and does not constitute the prior art.

A cooking appliance is one of home appliances for cooking food, and is an appliance installed in a kitchen space to cook food according to a user's intention. Such cooking appliances may be classified in various ways according to a used heat source, a form thereof, and a type of fuel.

Among such cooking appliances, there is a cooktop on which an object to be cooked is placed and which heats the object using a heat source disposed thereunder.

The cooktop may be provided with a heating coil that generates heat upon receiving electricity, and an upper plate which is disposed on top of the heating coil, wherein a container containing food is placed on an upper surface of the upper plate.

It is efficient that an entirety of heat generated from the heating coil passes through the upper plate and is transferred to the container placed on the upper plate. However, not the entirety of the heat generated from the heating coil is transferred to the upper plate, but a portion thereof may be transferred in a direction toward other components of the cooktop.

The cooktop may be provided with a top plate for supporting the upper plate, and the top plate may be disposed adjacent to the heating coil.

In general, the top plate may be made of a metal material that may be easily rolled in order to increase manufacturability. The top plate made of the metal may be a very effective heat dissipation means. Therefore, the portion of the heat that is not transferred to the upper plate but is discharged to the outside through other components or a gap between parts accommodating the heating coils may be discharged to the outside from the top plate made of the metal material. Thus, a significant amount of heat may not be used to heat the container containing the food and may be discharged into the atmosphere.

Such a structure may degrade the performance of the cooktop and the cooking appliance. Therefore, there is a need for a structure capable of preventing the heat from the heating coil from being discharged through other parts of the cooktop other than the upper plate to the atmosphere so that the heat from the heating coil is not used for heating the container.

### DISCLOSURE

### Technical Purpose A purpose of the present disclosure is to provide a cooking appliance having a structure capable of suppressing heat transfer in a lateral direction of a cooktop.

Further, a purpose of the present disclosure is to provide a cooking appliance having a structure capable of effectively suppressing heat transfer from a heating unit to a top plate.

In addition, a purpose of the present disclosure is to provide a cooking appliance having a structure capable of effectively suppressing heat transfer in a radiation manner in a lateral direction of a cooktop.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

### Technical Solution

An embodiment of a cooking appliance may comprise a cooktop comprising: a heating unit configured to heat an object; an upper plate disposed on top of the heating unit; and a top plate constructed to accommodate therein a portion of the heating unit, wherein the upper plate is disposed on an upper surface thereof.

The top plate may comprise: a cutout formed by cutting a portion of the top plate in which the heating unit is disposed, wherein the upper plate and the heating coil of the heating unit received in the cutout face each other; and a bent extension portion bent at an outer edge of the cutout so as to extend downwardly, wherein an air gap may be formed between the casing and the bent extension portion so as to block heat transfer in a conduction manner.

The air gap allows the heating unit and the top plate to be spaced apart from each other in the lateral direction, thereby effectively suppressing heat generated in the heating unit from being transferred in the lateral direction of the cooktop.

The casing may comprise: a bottom surface portion on which the heating coil may be accommodated; and a ring-shaped cylindrical side surface portion surrounding an outer side of the bottom surface portion and protruding upwardly, wherein the cylindrical side surface portion and the bent extension portion may be spaced from each other in a lateral direction such that the air gap may be formed therebetween.

The heating unit may comprise a thermal insulation cover disposed on top of the casing and constructed to suppress transfer of heat generated from the heating coil to an outside out of the casing. The bent extension portion may be laterally spaced apart from the thermal insulation cover and the cylindrical side surface portion such that the air gap may be defined therebetween.

The heating unit may comprise a thermal insulation pad disposed under the heating coil, wherein the casing may be disposed to surround at least a portion of each of a bottom surface and a side surface of the thermal insulation pad.

Another embodiment of the cooking appliance may comprise a thermal insulation layer disposed in the air gap and constructed to suppress heat transfer in a lateral direction.

The thermal insulating layer may fill the air gap to suppress heat generated from the heating unit from being transferred to the top plate in a convection and radiation manner and in a lateral direction.

Another embodiment of the cooking appliance may comprise a reflective layer disposed in the air gap, and disposed inwardly of the thermal insulation layer, wherein the reflective layer reflects heat transferred thereto from the heating unit in a radiation manner.

The reflective layer may reflect heat transferred in a radiation manner from the heating unit to suppress heat dissipation through the lateral direction of the cooktop.

The top plate may comprise: a cutout formed by cutting a portion of the top plate in which the heating unit is disposed, wherein the upper plate and the heating coil of the heating unit received in the cutout face each other, wherein the cutout may include at least one integrated cutout, each integrated cutout accommodating therein a combination of the heating units adjacent to each other.

The air gap, the thermal insulation layer, and the reflective layer are provided along the outer edge of the integrated cutout to suppress heat transfer to the top plate in the lateral direction of the cooktop.

### Technical Effect

In the cooking appliance according to the present disclosure, the bent extension portion of the top plate is laterally spaced from the casing of and/or the thermal insulation cover of the heating unit such that the air gap is formed between the top plate and the heating unit, thereby suppressing conduction-based heat transfer due to contact and effectively improving heating efficiency of the cooktop.

In addition, in the cooking appliance according to the present disclosure, the thermal insulation layer may be disposed in a space formed as the air gap. Therefore, the thermal insulation layer may be disposed between the inner side surface of the bent extension portion, the outer side surface of the thermal insulation cover, and the outer side surface of the cylindrical side surface portion.

Accordingly, the thermal insulation layer fills the air gap, thereby effectively suppressing the heat generated from the heating unit from being transferred to the top plate in a convection and radiation manner and in the lateral direction. In addition, in the cooking appliance according to the present disclosure, the integrated cutout is positioned, and the air gap, the thermal insulation layer, and the reflective layer are positioned along the outer edge of the integrated cutout so that heat transfer to the top plate in the lateral direction of the cooktop is suppressed, thereby improving the heating efficiency of the cooktop.

In addition, in the cooking appliance according to the present disclosure, the reflective layer may be disposed inwardly of the thermal insulation layer, and may be attached to the inner side surface of the thermal insulation layer and may have the fixed position. The reflective layer may reflect heat transferred in a radiation manner from the heating unit such that the heat is returned to the heating unit again.

Accordingly, the reflective layer is provided at a position facing the heating unit in the lateral direction to suppress heat transfer in a radiation manner in the lateral direction, thereby improving the heating efficiency of the cooktop.

In addition to the above-described effects, specific effects of the present disclosure will be described together while describing specific matters for implementing the present disclosure.

### BRIEF DESCRIPTION OF DRAWINGS

FIG. 1 is a diagram illustrating a cooking appliance according to an embodiment.

FIG. 2 is an exploded view of a cook top according to an embodiment.

FIG. 3 is a perspective view of a heating unit according to an embodiment.

FIG. 4 is a plan view of a heating unit according to an embodiment.

FIG. 5 is an exploded view of a portion of a heating unit according to an embodiment.

FIG. 6 is a cross-sectional view of a cook top according to an embodiment.

FIG. 7 is a bottom perspective view of a cooktop according to an embodiment.

FIG. 8 is a cross-sectional view of a cook top according to another embodiment.

FIG. 9 is an exploded view of a cooktop including a heating unit shown in FIG. 8.

FIG. 10 is a perspective view of FIG. 9.

FIG. 11 is a diagram of FIG. 9 as viewed in another direction.

FIG. 12 is a perspective view of FIG. 11.

FIG. 13 is a cross-sectional view of a cook top according to another embodiment.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, etc. are used to describe various components, these components are not limited by these terms. These terms are merely used to distinguish one component from another component. Thus, unless specifically stated to the contrary, the first component may be the second component.

As used herein, unless otherwise stated, each component may be provided as one or more components.

As used herein, the singular constitutes “a” and “an” are intended to comprise the plural constitutes as well, unless the context clearly indicates otherwise. Further, the terms “comprise”, “comprising”, “have”, and “having” as used herein should not be construed as necessarily comprising all of various components or steps as described herein, and may be construed as excluding some components or some steps thereof. It will be further understood that the terms “comprise”, “comprising”, “have”, and “having” as used herein specify presence of a component or a step, but do not preclude the presence or addition of another component or step.

Throughout the present disclosure, “A and/or B” means A, B, or A and B, unless otherwise specified, and “C to D” means C inclusive to D inclusive unless otherwise specified.

Throughout the present disclosure, “up-down direction” refers to the up-down direction of a cooking appliance in a state in which the cooking appliance is installed to be used on a daily basis. As used herein, “left-right direction” means a direction orthogonal to the up-down direction, and the front-rear direction means a direction orthogonal to both the up-down direction and the left-right direction. As used herein, “direction between both opposing sides” or “lateral direction” has the same meaning as the left-right direction, and these terms may be used interchangeably with each other herein.

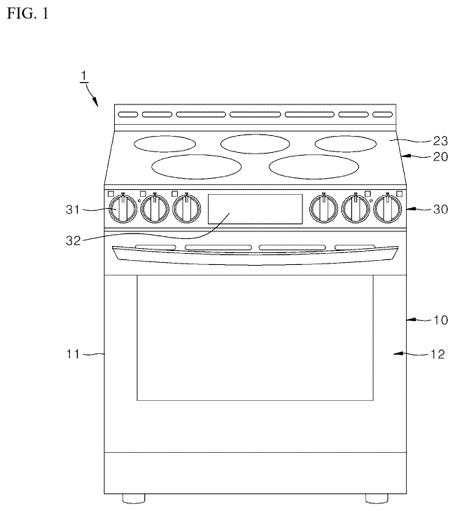

FIG. 1 is a diagram illustrating a cooking appliance according to an embodiment. As illustrated, a cooking appliance 1 according to an embodiment may comprise a cooktop 20. For example, the cooking appliance 1 may be a multi-functional cooking appliance 1 and may comprise a cooktop 20 and an oven 10, and the cooktop 20 may be disposed on top of the oven 10. In another example, the cooking appliance 1 may be configured to have the cooktop 20 alone, and may be built in a furniture cabinet such as a sink or may be placed in a freestanding manner.

Hereinafter, the structure of the multi-functional cooking appliance in which the cooktop 20 is disposed on top of the oven 10 will be described in detail.

The oven 10 may comprise a main body 11 in which a cavity having an open front surface is formed, and a door 12 connected to the main body 11 to open and close the cavity. The cavity have a cooking space defined therein, and a heating source such as a heater or a burner is disposed therein to heat the cooking space to cook food.

In addition, the cooktop 20 may be disposed on top of the oven 10. A container containing food to be cooked may be seated on an upper plate 23 of the cooktop 20, and the container may be heated by a heating unit 22 disposed under the upper plate 23.

The cooking appliance 1 may comprise a manipulator 30. In an example, the manipulator 30 may comprise a plurality of knobs 31, and may manipulate operations of the oven 10 and the cooktop 20.

If necessary, the manipulator 30 may be embodied as a button, a switch, or a touch manipulating device. The manipulator 30 may be disposed on the cooktop 20. In addition, a display 32 for displaying an operating state of the cooking appliance 1 may be provided on one side of the manipulator 30.

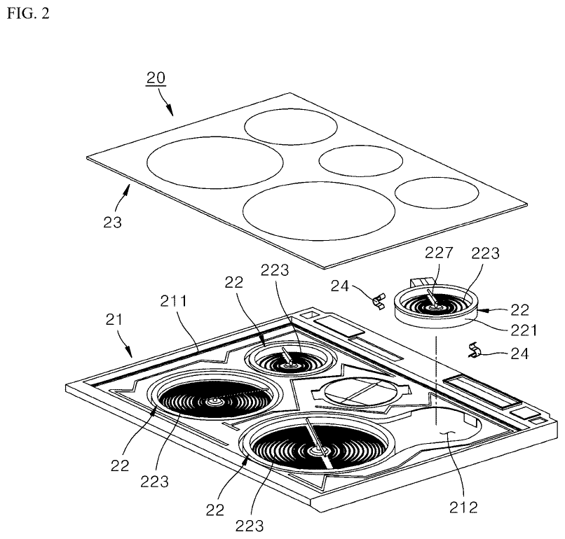

Hereinafter, a structure of the cooktop 20 will be described in more detail with reference to the drawings. FIG. 2 is an exploded view of a cook top 20 according to an embodiment.

As illustrated, the cooktop 20 may comprise a top plate 21, the heating unit 22, and the upper plate 23.

The top plate 21 may accommodate therein a portion of the heating unit 22, and the upper plate 23 may be disposed on an upper surface thereof. The top plate 21 may be formed in a rectangular shape and may constitute an entire frame of the cooktop 20. In addition, the top plate 21 may provide a structure in which the heating unit 22 and the upper plate 23 may be mounted thereto.

For example, the top plate 21 may be made of a metal material, and may constitute a lower portion of the cooktop 20. In the structure in which the cooktop 20 is independently installed, the top plate 21 may define the outer appearance of the remaining portion except for the upper surface of the cooktop 20.

A cutout 212 for mounting the heating unit 22 therein may be formed in the top plate of the cooktop 20. The cutout 212 may be formed to be cut in an area of the top plate where the heating unit 22 is disposed so that the upper plate 23 and a heating coil 223 received in the cutout face each other. The heating unit 22 may be received inside the cutout 212.

A plurality of heating units 22 may be mounted in the cooktop 20. The number of cutouts 212 formed in the top plate 21 may correspond to the number of the heating units 22. As will be described later, when the two cutouts 212 are integrated into one cutout, the two heating units 22 corresponding to the two cutouts may correspond to the one integrated cutout 212.

The heating unit 22 may heat an object. Here, the object is placed on the upper surface of the upper plate 23 and may be a container containing therein the food to be cooked.

The heating unit 22 may be mounted inside the cutout 212, and may be fixedly mounted in the top plate 21. The heating unit 22 may be configured in various ways according to the type of a heat source. The heating unit may be configured to heat the container placed on the upper surface of the upper plate 23. Hereinafter, for example, the heating unit 22 provided as an electric resistance type heating device will be described.

In one example, the upper plate 23 may be mounted on the upper surface of the top plate of the cooktop 20. The upper plate 23 defines an upper surface of the cooktop 20. The heating unit 22 may be shielded by the upper plate disposed on top of the heating unit while the upper plate is in a mounted state.

In order to mount the upper plate 23, an upper plate receiving space 211 recessed downwards may be formed in the upper surface of the top plate 21. The upper plate receiving space 211 may be recessed so as to have a size corresponding to that of the upper plate 23. In addition, a recessed depth of the upper plate receiving space 211 may correspond to a thickness of the upper plate 23. In addition, a plurality of cutouts 212 may be located in an inner area of the upper plate receiving space 211.

The upper plate 23 may be disposed on top of the heating unit 22. The upper plate 23 is formed in a planar shape to define an upper surface of the cooktop 20, and at the same time, the container to be heated may be seated on the upper plate. Accordingly, the upper plate 23 may be made of a plate-shaped moldable material having heat resistance and high flatness.

For example, the upper plate 23 may be made of a heat-resistant glass, a tempered glass, a ceramic glass, or the like. In addition, the upper plate 23 may be formed to be transparent or opaque. In addition, the upper plate 23 may be formed to have a smooth surface to prevent contamination and discoloration and to maintain excellent cleaning properties.

In addition, a container guide may be formed in the upper plate 23 at a position corresponding to the heating unit 22. The container guide may be positioned vertically above the heating unit 22 and may be formed so as to overlap a circumference of the heating unit 22.

For example, the container guide may be formed in a circular shape corresponding to a shape of the circumference of the heating unit 22. In this case, the container guide may be formed, for example, in a manner of being printed on the upper surface of the upper plate 23.

In one example, the cooktop 20 may comprise a spring 24. The spring 24 may be provided to couple the heating unit 22 to the top plate 21. For example, a plurality of springs 24 may be arranged to be spaced apart from each other in the circumferential direction of a casing 221 of the heating unit 22.

A portion of the spring 24 may be coupled to the heating unit 22, and a portion thereof may be coupled to the top plate 21 to allow the heating unit 22 to be disposed in the cutout 212 of the top plate 22. The spring 24 may be formed in a “C” shape, for example. However, the present disclosure is not limited thereto.

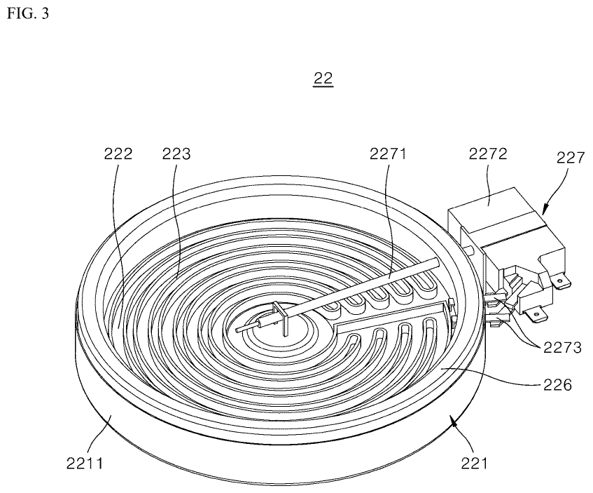

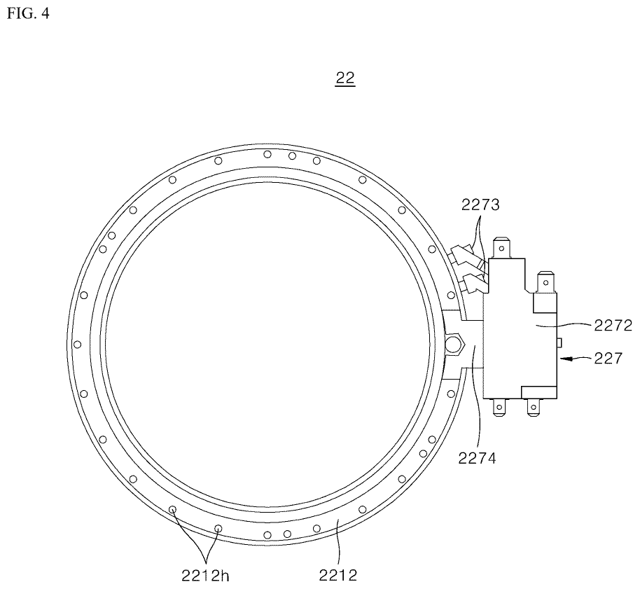

FIG. 3 is a perspective view of a heating unit according to an embodiment. FIG. 4 is a plan view of a heating unit according to an embodiment. The heating unit 22 may comprise the heating coil 223, the casing 221, and a thermistor 227. First, the thermistor 227 will be described. The thermistor 227 may be disposed in the heating unit to measure a temperature of the heating coil 223.

The thermistor 227 may be configured to comprise a thermostat 2271, a housing 2272, a terminal 2273, and a fixing bracket 2274. The thermostat 2271 may measure the temperature of the heating coil 223 and may extend toward a central portion of the heating coil 223.

The thermostat 2271 may sense the temperature of the heating coil 223 to measure the temperature of a position on top of the heating coil 223. The thermostat 2271 is disposed to be slightly spaced apart from the heating coil 223 without being in contact with the heating coil 223, such that the temperature of the area on top of the heating coil 223 may be measured by the thermostat 2271.

The housing 2272 may be coupled to the thermostat 2271, and a device for electrically connecting the heating coil 223 and an external power source to each other may be accommodated therein. In addition, a switch device capable of controlling on/off of the heating coil 223 by connecting and discontenting the heating coil 223 to and from the power source may be provided inside the housing 2272.

When the temperature of the heating coil 223 measured by the thermostat 2271 exceeds a set temperature, this indicates that the heating coil 223 is overheated. In this case, the switch device may operate to turn off the heating coil 223.

The terminal 2273 may be electrically connected to the heating coil 223 and protrude out of the casing 221. The external power source is electrically connected to the terminal 2273. The heating coil 223 may be heated when the electricity from the external power source is applied thereto.

The fixing bracket 2274 may protrude from the housing 2272, and an end thereof may be coupled to the casing 221. Accordingly, the housing 2272 may be fixedly coupled to the casing 221 by the fixing bracket 2274 so that the thermostat 2271 may maintain a designed position.

The heating coil 223 may generate heat upon receiving the electricity. In an embodiment, the heating coil 223 may be provided as a coil heated in an electrical resistance manner. In this regard, the heat generated from the heating coil 223 may pass through the upper plate 23 to heat the container containing therein the food via radiation or conduction. The casing 221 may accommodate therein the heating coil 223.

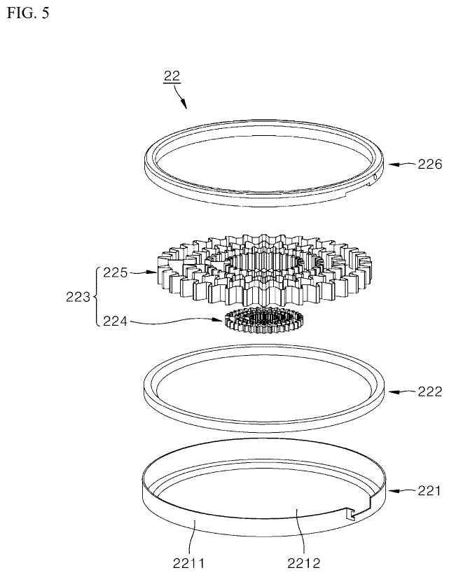

FIG. 5 is an exploded view of a portion of a heating unit according to an embodiment. In FIG. 5, the illustration of the thermistor 227 is omitted. As illustrated in FIG. 5, the casing 221 may comprise a cylindrical side surface portion 2211 and a bottom surface portion 2212.

The bottom surface portion 2212 may constitute a lower surface of the casing 221, may be generally formed in a circular shape, and may accommodate thereon the heating coil 223. The cylindrical side surface portion 2211 may surround an outer side of the bottom surface portion 2212, and protrude upwards, and be formed in a ring shape.

Due to this structure, the bottom surface portion 2212 and the cylindrical side surface portion 2211 may define a space capable of accommodating therein the heating coil 223 and the thermal insulation pad 222.

The cylindrical side surface portion 2211 may comprise a first surface bent from an edge of the bottom surface and a second surface bent from the first surface extending in a lateral direction. In this regard, a plurality of fastening holes 2212h for fastening the ring-shaped thermal insulation member to the second surface may be formed in the bottom of the second surface and may be arranged along a circumferential direction of the second surface.

Referring to FIG. 5, the heating unit 22 may comprise the thermal insulation pad 222 and a thermal insulation cover 226.

The thermal insulation pad 222 may be disposed under the heating coil 223, and the thermal insulation pad 222 may be disposed in a lower portion of the inner space of the casing 221 of the heating unit 22, and may be made of a thermal insulation material. Therefore, when the heating coil 223 generates the heat, the thermal insulation pad 222 may prevent the heat from being transferred downwards. In addition, the heating coil 223 may be disposed on top of the thermal insulation pad 222.

The casing 221 may be disposed to surround a bottom surface and at least a portion of a side surface of the thermal insulation pad 222. Due to this structure, the thermal insulation pad 222 may be stably accommodated in the casing 221 and may thermally insulate the lower surface of the heating coil 223.

The thermal insulation cover 226 may be disposed on top of the casing 221 and may prevent the heat generated from the heating coil 223 from being transferred to the outside. The thermal insulation cover 226 may be made of a thermal insulation material, and an upper end of the thermal insulation cover 226 may be provided to face a lower surface of the upper plate.

In this regard, the upper end of the thermal insulation cover 226 and the lower surface of the upper plate may be in contact with each other or may be slightly spaced apart from each other in the up-down direction depending on the design.

The thermal insulation cover 226 may prevent the heat generated from the heating coil 223 from being transferred in the lateral direction of the cooktop and may allow the heat to be transferred in the upward direction of the cooktop, thereby improving the thermal efficiency of the cooktop.

In one example, as illustrated in FIG. 5, the heating coil 223 may be divided into, for example, an inner coil 224 and an outer coil 225. Accordingly, the amount of heat for heating the container 2 may be adjusted according to a combination of on/off operations of the inner coil 224 and the outer coil 225.

In one embodiment, it is efficient that the entirety of the heat generated from the heating coil 223 passes through the upper plate 23 and is transferred to the container placed on the upper plate 23.

However, the heat generated in the heating coil 223 may be transferred in the lateral direction of the cooktop 20. For example, when the lower surface of the upper plate 23 and the upper surface of the thermal insulation cover 226 do not entirely contact each other, a gap may be defined between the lower surface of the upper plate 23 and the upper surface of the thermal insulation cover 226. Through this gap, heat may be transferred to the side surface of the cooktop 20 in a convection and radiation manner.

In addition, heat may be transferred to the side surface of the cooktop 20 in a conduction manner through the cylindrical side surface portion 2211 of the casing 221 or the thermal insulation cover 226. In this regard, the thermal insulation cover 226 is made of a thermal insulation material, the thermal insulation cover 226 may slightly suppress the lateral heat transfer of the cooktop 20. However, the thermal insulation cover 226 has a considerable length in the circumferential direction, such that the heat discharged in the lateral direction of the cooktop 20 through the thermal insulation cover 226 may never be negligible.

In addition, when the casing 221 is made of, for example, a metal having high thermal conductivity, a considerable amount of heat may be discharged in a lateral direction of the cooktop 20 through the cylindrical side surface portion 2211.

The heat transferred in the lateral direction of the cooktop 20 may be transferred to the top plate 21 surrounding the heating unit 22. The top plate 21 may be made of a metal material that may be easily rolled in order to increase manufacturability.

The top plate 21 made of the metal material may be a very effective heat dissipation means. Therefore, the heat discharged in the lateral direction of the cooktop 20 is discharged to the outside from the top plate 21 made of the metal material, and thus a considerable amount of heat is not used to heat the container and may be discharged to the atmosphere.

This structure may degrade the performance of the cooktop 20 and the cooking appliance 1. Therefore, a structure capable of suppressing the heat discharge of the heating unit 22 to the atmosphere from another portion of the heating unit 22 other than the upper plate 23 so as not to be used to heat the container of the heating coil 223 is required.

The structure of the cooking appliance 1 according to an embodiment for this purpose will be described in detail with reference to the drawings.

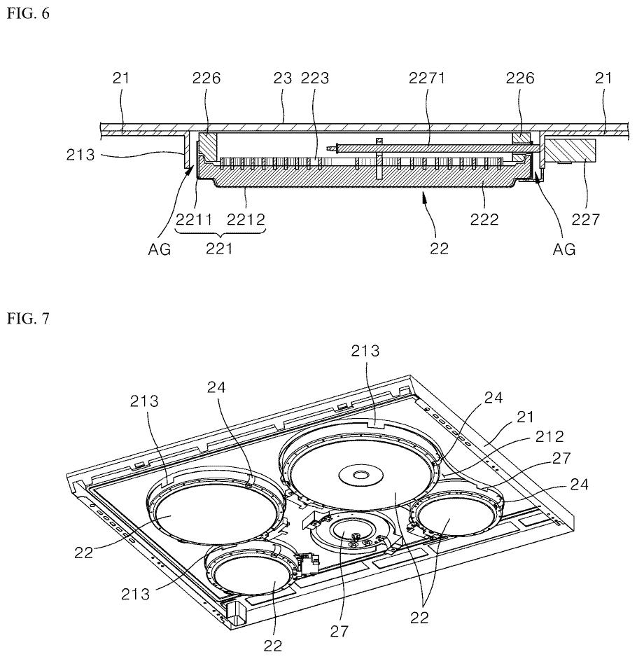

FIG. 6 is a cross-sectional view of the cooktop 20 according to an embodiment. FIG. 7 is a bottom perspective view of the cooktop 20 according to an embodiment.

The top plate 21 may comprise a bent extension portion 213 bent at an outer edge of the cutout 212 and extending downwards. The bent extension portion 213 may extend downwards from the outer edge of the cutout 212 in a cross-sectional view.

Since the heating unit 22 is disposed in the cutout 212, the bent extension portion 213 may be disposed to face the side surface of the thermal insulation cover 226 and/or the cylindrical side surface portion 2211 of the casing 221 in the lateral direction.

An air gap AG may be formed between the casing 221 and the bent extension portion 213 to block heat transfer in a conduction manner. The casing 221 and the bent extension portion 213 may be disposed to be spaced apart from each other in a lateral direction of the cooktop 20.

The gap may act as the air gap AG. In addition, in an area where the bent extension portion 213 is not formed, an end of the top plate 21 defining the outer edge of the cutout 212 and the casing 221 may be laterally spaced apart from each other to form an air gap AG defined therebetween.

Accordingly, a size of the cutout 212 may be larger than a size of the casing 221 of the heating unit 22, so that the air gap AG may be formed between the cutout 212 and the casing 221. In one example, an air gap AG may also be formed between the outer side surface of the thermal insulation cover 226 disposed on the upper surface of the casing 221 and the end of the top plate 21 defining the outer edge of the cutout 212.

The air gap AG may be formed as a space, and air may flow through the air gap. Since the heating unit 22 and the top plate 21 are laterally spaced apart from each other via the air gap AG defined therebetween, the heating unit 22 and the top plate 21 may not be in contact with each other. Accordingly, the heat generated in the heating unit 22 may be effectively suppressed from being transferred to the top plate 21 in a conduction manner due to the contact.

If the top plate 21 and the heating unit 22 are in contact with each other in the lateral direction without the air gap AG defined therebetween, the top plate 21 made of the metal having high thermal conductivity may be easily cooled down by the atmosphere and the heat may be smoothly transferred to the atmosphere.

Accordingly, when the top plate 21 and the heating unit 22 are in contact with each other, the amount of heat generated from the heating unit 22 is transferred in the lateral direction without passing through the upper plate 23, and thus the heating efficiency of the cooktop 20 may be lowered.

In an embodiment, the bent extension portion 213 of the top plate 21 may be laterally spaced from the casing 221 and/or the thermal insulation cover 226 of the heating unit 22 such that the air gap AG is formed between the top plate 21 and the heating unit 22, thereby suppressing the conduction-based heat transfer due to the contact and effectively improving heating efficiency of the cooktop 20.

The cylindrical side surface portion 2211 and the bent extension portion 213 are laterally spaced apart from each other such that the air gap AG may be formed therebetween. In addition, the bent extension portion 213 is laterally spaced apart from the thermal insulation cover 226 and the cylindrical side surface portion 2211 such that the air gap AG may be formed therebetween.

The bent extension portion 213 is disposed to face the cylindrical side surface portion 2211 and/or the thermal insulation cover 226 in the lateral direction. Thus, the bent extension portion 213 is spaced apart from the cylindrical side surface portion and/or the thermal insulation cover 226 in the lateral direction such that the air gap AG may be formed therebetween.

A plurality of bent extension portions 213 may be arranged to be spaced apart from each other along the outer edge of the cutout 212. Accordingly, there may be an area in the edge of the cutout 212 in which the bent extension portion 213 is not formed.

In the area where the bent extension portion 213 is not formed, the outer edge of the cutout 212 is spaced apart from the thermal insulation cover 226 in a lateral direction of the cooktop 20 such that the air gap AG may be formed therebetween. Accordingly, the air gap AG may be continuously formed in a shape corresponding to the shape of the cutout 212 and along the outer edge of the cutout 212.

The air gap AG may effectively suppress the conduction-based heat transfer due to contact between the components. However, the air gap AG is a space through which air flows. Thus, it is difficult to suppress heat transfer in the convection and radiation manner through the air gap.

Therefore, hereinafter, a structure capable of effectively suppressing the lateral heat transfer from the heating unit 22 to the top plate 21 in a convection and radiation manner will be described.

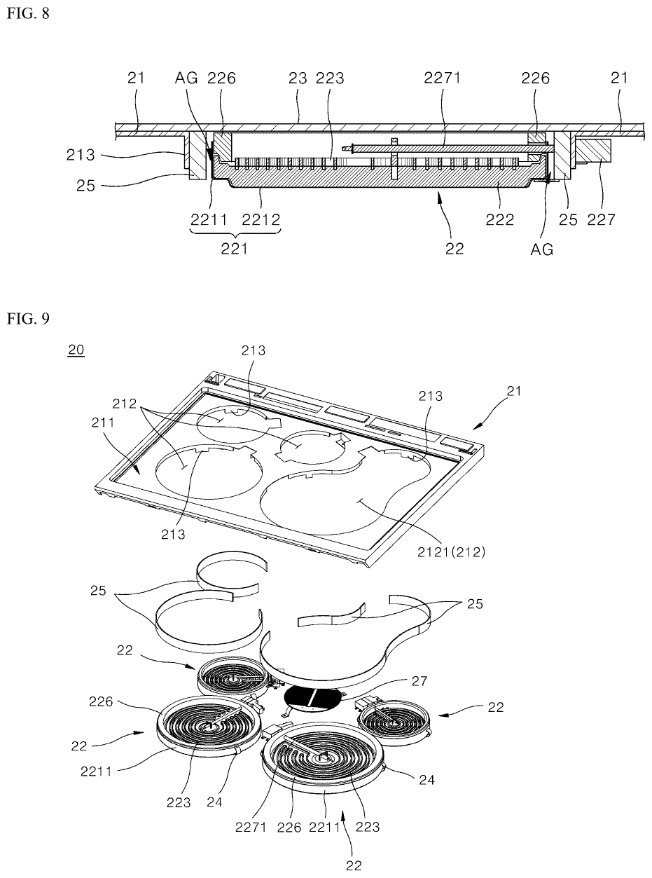

FIG. 8 is a cross-sectional view of the cooktop 20 according to another embodiment. FIG. 9 is an exploded view of the cooktop 20 including the heating unit 22 illustrated in FIG. 8. The cooking appliance 1 may comprise a thermal insulation layer 25 disposed in the air gap AG and constructed to suppress the heat transfer in a lateral direction.

The air gap AG may be formed in all of the plurality of cutouts 212. Thus, similarly, the thermal insulation layer 25 may be disposed in all of the plurality of cutouts 212. The thermal insulation layer 25 may be formed in a generally flat and long shape and may be disposed in the air gap AG.

The thermal insulation layer 25 may be made of a material having high heat resistance and a good thermal insulation effect. For example, the thermal insulation layer 25 may be made of Teflon or silicon resin, or may be made of a material including at least one of Al₂O₃, SiO₂, and TiO₂ having good heat resistance and heat insulation. However, the present disclosure is not limited thereto.

Since the thermal insulation layer 25 is disposed in the air gap AG, the thermal insulation layer 25 may be formed in a shape corresponding to the shape of the cutout 212 and may extend along the outer edge of the cutout 212. The thermal insulation layer 25 may continuously extend along the outer edge of the cutout 212, or may extend in a discontinuous manner along the outer edge of the cutout 212 such that portions of the thermal insulation layer 25 are spaced apart from each other.

Such a discontinuous shape may be intended to avoid overlapping with other components in which the air gap AG is defined, or to facilitate convenience in assembling the thermal insulation layer 25.

For example, referring to FIG. 9, in an area in which the housing 2272 protrudes out of the casing 221, the thermal insulation layer 25 is not disposed in a position corresponding to the housing 2272, such that the thermal insulation layer 25 may discontinuously extend along the outer edge of the cutout 212.

The thermal insulation layer 25 may be disposed in a space embodied as the air gap AG. Accordingly, the thermal insulation layer 25 may be disposed between an inner side surface of the bent extension portion 213, an outer side surface of the thermal insulation cover 226, and the outer side surface of the cylindrical side surface portion 2211.

Accordingly, the thermal insulation layer 25 fills the air gap AG, thereby effectively suppressing the heat generated from the heating unit 22 from being transferred to the top plate 21 in a convection and radiation manner in the lateral direction.

The thermal insulation layer 25 may be formed in a shape corresponding to the shape of the outer edge of the cutout 212. Accordingly, the thermal insulation layer 25 may be formed in a circular shape corresponding to the circular cutout 212.

In addition, when the integrated cutout 2121 to be described later is formed, the thermal insulation layer 25 may be formed in a shape corresponding to a shape of the integrated cutout 2121, for example, a peanut or dumbbell shape in which two circles are combined with each other.

Referring to FIG. 9, the cooktop 20 may comprise a warming unit 27. The warming unit 27 refers to a device for heating food contained in a container placed on top thereof or maintaining the warmth of the food. Accordingly, the warming unit 27 may discharge the heat of a temperature lower than that of the heating unit 22.

The air gap AG may be formed along the cutout 212 in which the warming unit 27 is disposed. However, the amount of heat discharged from the warming unit 27 is much smaller than the amount of heat discharged from the heating unit 22, such that the amount of lateral heat transfer between the warming unit 27 and the top plate 21 may be significantly smaller than the amount of lateral heat transfer between the heating unit 22 and the top plate 21.

Accordingly, when the thermal insulation layer 25 is disposed in the cutout 212 in which the warming unit 27 is disposed, the thermal insulation layer 25 surrounding the warming unit 27 may not be provided in consideration of the relatively small thermal insulation effect thereof and the effort and cost of forming the thermal insulation layer 25.

The thermal insulation layer 25 may be provided to be attached to at least one of the inner side surface of the bent extension portion 213 or the lower surface of the upper plate 23. Accordingly, the position of the thermal insulation layer 25 may be fixed.

In another embodiment, the thermal insulation layer 25 may be provided to be attached to the outer surface of the heating unit 22, that is, the thermal insulation cover 226 and/or the cylindrical surface part 2211. However, in this case, the heating unit 22 and the thermal insulation layer 25 may be in direct contact with each other so that heat generated from the heating unit 22 may be transferred to the thermal insulation layer 25 in a conduction manner.

In this regard, the thermal insulation layer 25 has a significantly low heat transfer effect. However, when the thermal insulation layer 25 is made of a material having a relatively low thermal insulation effect, heat loss in the conduction manner-based heat transfer may occur in the thermal insulation layer 25.

Accordingly, it may be appropriate to attach the thermal insulation layer 25 to the bent extension portion 213 and/or the upper plate 23 to prevent the thermal insulation layer 25 and the heating unit 22 from contacting each other so that the heat transfer in the conduction manner does not occur, thereby preventing the heat loss.

The thermal insulation layer 25 may be formed in one of a form in which the inside thereof is filled or a form in which the inside thereof is hollow. For example, when the material of the thermal insulation layer 25 has a large thermal insulation effect, it may be appropriate to use the thermal insulation layer 25 in the form in which the inside thereof is filled.

In this case, there is little heat transfer in the conduction manner through the thermal insulation layer 25, and there is no heat transfer in the convection manner inside the thermal insulation layer 25, so that the thermal insulation effect of the thermal insulation layer 25 may be improved.

On the contrary, when the material of the thermal insulation layer 25 has a relatively small thermal insulation effect, the heat transfer in the conduction manner may occur through the thermal insulation layer 25, thereby causing the heat loss of the heating unit 22. In this case, the insulating layer 25 having the form in which the inside thereof is hollow may be used.

In this case, the inside of the thermal insulation layer 25 is in the hollow state, such that the heat transfer in the conduction manner inside the thermal insulation layer 25 may be effectively blocked.

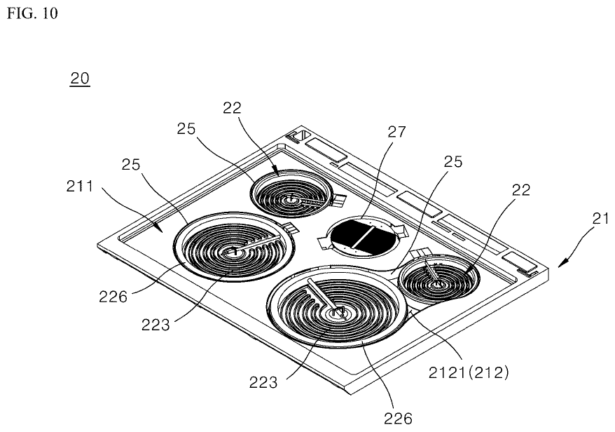

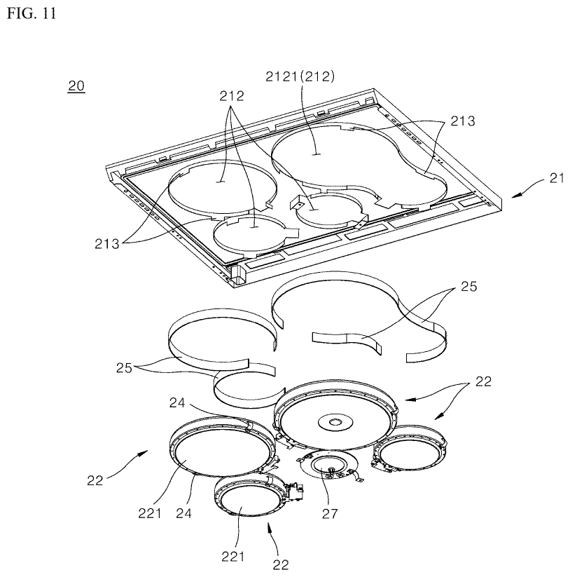

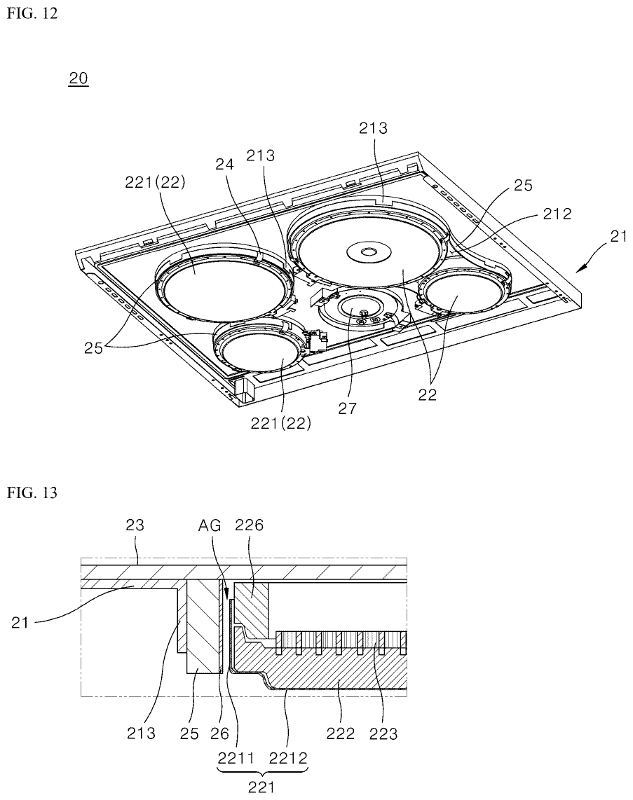

FIG. 10 is a perspective view of FIG. 9. FIG. 11 is a diagram of FIG. 9 as viewed in another direction. FIG. 12 is a perspective view of FIG. 11.

The plurality of heating units 22 may be provided. The cutouts 212 in which the heating units 22 are respectively disposed may also be arranged to be spaced apart from each other and may be defined in the top plate 21. The number of the cutouts may be in correspondence to the number of the heating units 22. However, the number of heating units 22 and the number of cutouts 212 may not necessarily correspond to each other. This is because the cutouts 212 may be integrated with each other into the integrated cutout 2121.

In the cooktop 20 of the embodiment, the plurality of heating units 22 may be provided, and the cutout 212 may comprise at least one integrated cutout 2121 for integrally accommodating therein heating units 22 adjacent to each other.

The integrated cutout 2121 may be formed in a peanut or dumbbell shape in which circular cutouts 212 spaced apart from each other are integrated with each other. The integrated cutout 2121 may be formed by cutting a partial piece that constitutes a portion of an upper portion of the top plate 21 disposed between the cutouts 212 spaced apart from each other.

If there is a partial piece of the top plate 21 that spaces the adjacent cutouts 212 apart from each other, heat transfer may occur from the heating unit 22 to the partial piece and the heat may be spread to the entirety of the top plate 21.

In this structure, the amount of heat directly transferred from the heating unit 22 to the container through the upper plate 23 may be reduced, and the amount of heat discharged to the atmosphere through the top plate 21 may be increased.

In an embodiment, the integrated cutout 2121 is provided. The air gap AG, the thermal insulating layer 25, and a reflective layer 26 to be described later are disposed along the outer edge of the integrated cutout 2121 to suppress the heat transfer to the top plate 21 in the lateral direction of the cooktop 20, thereby improving heating efficiency of the cooktop 20.

That is, the integrated cutout 2121 is formed to remove a portion of the piece of the top plate 21, such that the heat dissipation area of the upper portion of the top plate 21 may be reduced, thereby improving the heating efficiency of the cooktop 20.

Referring to FIG. 11, the thermal insulation layer 25 may be provided to surround the neighboring heating units 22 accommodated in the same integrated cutout 2121, and to be absent in an area defined between the neighboring heating units 22.

The heat transfer between the heating units 22 may occur in the area defined between the neighboring heating units 22. However, in this area, the heat may not be transferred to the top plate 21, and may be transferred to the container through the upper plate 23 disposed on top of this area.

Therefore, the thermal insulation layer 25 and the reflective layer 26 to be described later may not be disposed in the area defined between the neighboring heating units 22.

In order to increase the heating efficiency, the number of the integrated cutouts 2121 is increased, the heating efficiency may be more improved. However, when the number of the integrated cutouts 2121 is increased, a total area size of the cutouts 212 defined in the top plate 21 is increased, and accordingly, the rigidity of the top plate 21 may be weakened.

When the rigidity of the top plate 21 is weakened, it may be difficult for the top plate 21 to support the upper plate 23 disposed on top of the top plate 21. Therefore, in order to support the upper plate 23, the top plate 21 requires proper rigidity.

Accordingly, the number of integrated cutouts 2121 formed in the top plate 21 may be appropriately adjusted in consideration of the increase in heating efficiency of the cooktop 20 and the rigidity of the top plate 21. In the illustrated embodiment, in consideration of this, three cutouts 212 and one integrated cutout 2121 are provided in the cooktop 20 having four heating units 22 and one warming unit 27. However, the present disclosure is not limited thereto, and the number of the heating units 22 and the number of the warming units 27 and the number of the cutouts 212 and the number of the integrated cutouts 2121 may be adjusted to vary.

FIG. 13 is a cross-sectional view of a cooktop 20 according to another embodiment. Heat transfer in the radiation manner may occur in a lateral direction from the heating unit 22. The radiation-based heat transfer degrades the heating efficiency of the cooktop 20. For this reason, a structure for suppressing the radiation-based heat transfer is required. To this end, in an embodiment, the reflective layer 26 may be provided.

The cooktop 20 according to the embodiment may comprise the reflective layer 26 disposed in the air gap AG, disposed inwardly of the thermal insulation layer 25, and constructed to reflect the heat radiated from the heating unit 22 therefrom. The reflective layer 26 may be disposed to face the thermal insulation cover 226 and the cylindrical side surface portion 2211.

The reflective layer 26 may be disposed inwardly of the thermal insulation layer 25, and may be attached to the inner side surface of the thermal insulation layer 25 and be fixed in position. The reflective layer 26 may reflect heat transferred in a radiation manner from the heating unit 22 therefrom such that the heat is returned to the heating unit 22 again.

The reflective layer 26 may be formed in a plate shape having a thickness smaller than that of the thermal insulation layer 25, and may be formed in a shape corresponding to that of the thermal insulation layer 25 and/or the cutout 212 and/or the integrated cutout 2121.

The reflective layer 26 may be made of, for example, an aluminum material having high thermal reflectance and high corrosion resistance. Alternatively, the reflective layer 26 may be made of a non-metal or a metal material in which a mirror surface having high thermal reflectance is formed in a portion thereof facing the thermal insulation cover 226 and the cylindrical side surface portion 2211 of the heating unit 22.

For example, a component to which the reflective layer 26 and the thermal insulation layer 25 are attached may be manufactured, and the component may be disposed in the air gap AG so that the reflective layer 26 is placed inwardly of the insulation layer 25 to easily manufacture the cooktop 20 provided with the reflective layer 26 and the thermal insulation layer 25.

The reflective layer 26 may be disposed to be laterally spaced apart from the thermal insulation cover 226 and the cylindrical side surface portion 2211. When the reflective layer 26 contacts the thermal insulation cover 226 and the cylindrical side surface portion 2211 of the heating unit 22, heat generated from the heating unit 22 may be transferred to the reflective layer 26 and the thermal insulation layer 25 in the conduction manner, thereby causing unnecessary heat loss.

In particular, when the reflective layer 26 is made of a metal material having high thermal conductivity, heat loss may increase in the lateral direction of the cooktop 20 in the conduction manner. Therefore, in the embodiment, the reflective layer 26 and the heating unit 22 may be laterally spaced apart from each other so as not to contact each other. Accordingly, heat loss in the lateral direction of the cooktop 20 may be effectively suppressed.

In the embodiment, the reflective layer 26 is provided at a position facing the heating unit 22 in the lateral direction to suppress heat transfer in the radiation manner in the lateral direction, thereby improving the heating efficiency of the cooktop 20.

Although the present disclosure has been described above with reference to the drawings, the present disclosure is not limited to the embodiments disclosed herein and the drawings, and it is obvious that various modifications may be made thereto by those skilled in the art within the scope of the technical idea of the present disclosure. In addition, even when the effects according to the configurations of the present disclosure were not explicitly described while describing the embodiments of the present disclosure, it is obvious that the effects predictable from the configurations should also be acknowledged.

1. A cooking appliance comprising a cooktop, wherein the cooktop comprises:
a heating unit for heating an object;
an upper plate disposed on top of the heating unit; and
a top plate accommodating therein a portion of the heating unit, wherein the upper plate is disposed on an upper surface of the top plate,
wherein the heating unit comprises:
a heating coil receiving electricity to generate heat; and
a casing accommodating therein the heating coil,
wherein the top plate comprises:
a cutout formed by cutting a portion of the top plate in which the heating unit is disposed, wherein the upper plate and the heating coil of the heating unit received in the cutout face each other; and
a bent extension portion bent at an outer edge of the cutout so as to extend downwardly,
wherein an air gap is formed between the casing and the bent extension portion.

2. The cooking appliance of claim 1, wherein the casing comprises:
a bottom surface portion on which the heating coil is accommodated; and
a ring-shaped cylindrical side surface portion surrounding an outer side of the bottom surface portion and protruding upwardly,
wherein the cylindrical side surface portion and the bent extension portion are spaced from each other in a lateral direction such that the air gap is formed therebetween.

3. The cooking appliance of claim 2, wherein the heating unit comprises a thermal insulation cover disposed on top of the casing and constructed to suppress transfer of heat generated from the heating coil to an outside out of the casing.

4. The cooking appliance of claim 3, wherein the bent extension portion is laterally spaced apart from the thermal insulation cover and the cylindrical side surface portion such that the air gap is defined therebetween.

5. The cooking appliance of claim 3, wherein the heating unit comprises a thermal insulation pad disposed under the heating coil,
wherein the casing is disposed to surround at least a portion of each of a bottom surface and a side surface of the thermal insulation pad.

6. The cooking appliance of claim 1, wherein the bent extension portion includes a plurality of bent extension portions arranged so as to spaced apart from each other along the outer edge of the cutout.

7. The cooking appliance of claim 3, wherein the cooking appliance further comprises a thermal insulation layer disposed in the air gap and constructed to suppress heat transfer in a lateral direction.

8. The cooking appliance of claim 7, wherein the thermal insulation layer is disposed between an inner side surface of the bent extension portion, an outer side surface of the thermal insulation cover, and an outer side surface of the cylindrical side surface portion.

9. The cooking appliance of claim 7, wherein the thermal insulation layer is formed in a shape corresponding to an shape of the outer edge of the cutout.

10. The cooking appliance of claim 7, wherein the thermal insulation layer is provided to be attached to at least one of an inner side surface of the bent extension portion or a lower surface of the upper plate.

11. The cooking appliance of claim 7, wherein the thermal insulation layer is formed in one of a form in which an inside thereof is filled or a form in which the inside thereof is hollow.

12. The cooking appliance of claim 7, wherein the cooking appliance further comprises a reflective layer disposed in the air gap and disposed inwardly of the thermal insulation layer, wherein the reflective layer reflects heat transferred thereto from the heating unit in a radiation manner.

13. The cooking appliance of claim 12, wherein the reflective layer is disposed to face the thermal insulation cover and the cylindrical side surface portion, and is disposed to be laterally spaced apart from the thermal insulation cover and the cylindrical side surface portion.

14. The cooking appliance of claim 7, wherein the heating unit includes a plurality of heating units,
wherein the cutout includes at least one integrated cutout, each integrated cutout accommodating therein a combination of the heating units adjacent to each other.

15. The cooking appliance of claim 14, wherein the thermal insulation layer surrounds the heating units accommodated in the same integrated cutout and adjacent to each other, and is absent in an area defined between the heating units adjacent to each other.
